(19) United States
(12) Patent Application Publication
(10) Pub. No.: US 2024/0375551 A1
(43) Pub. Date: Nov. 14, 2024

(54) SEAT CONTROL APPARATUS AND METHOD

(71) Applicants: HYUNDAI MOTOR COMPANY, Seoul (KR); KIA CORPORATION, Seoul (KR)

(72) Inventors: Kug Hun Han, Seoul (KR); Sang Soo Lee, Hwaseong-si (KR); Yo Han Kim, Ansan-si (KR); Dong Hoon Lee, Hwaseong-si (KR); Deok Soo Lim, Hwaseong-si (KR); Sang Hark Lee, Incheon (KR)

(73) Assignees: HYUNDAI MOTOR COMPANY, Seoul (KR); KIA CORPORATION, Seoul (KR)

(21) Appl. No.: 18/385,228

(22) Filed: Oct. 30, 2023

(30) Foreign Application Priority Data
May 14, 2023 (KR) 10-2023-0062091

(51) Int. Cl. B60N 2/02

(52) U.S. Cl. CPC B60N 2/0252; B60N 2/02246

(57) ABSTRACT

A seat control apparatus includes an input device, a driving device, a memory that stores instructions, and a control device electrically connected to the input device, the driving device, and the memory. The seat control apparatus identifies an operating mode included in an operation input when receiving the operation input to a target seat through the input device, identifies a specified state of at least one adjacent seat adjacent to the target seat based on the operating mode, allows the at least one adjacent seat to be in the specified state by using the driving device, and allows the target seat to be in the operating mode by using the driving device.

### CROSS-REFERENCE TO RELATED APPLICATION

This application claims the benefit of priority to Korean Patent Application No. 10-2023-0062091, filed in the Korean Intellectual Property Office on May 14, 2023, the entire contents of which are incorporated herein by reference.

### TECHNICAL FIELD

The present disclosure relates to a seat control apparatus and a method thereof. More particularly, the present disclosure relates to a technology that allows a user to change to change an operating mode of a target seat corresponding to an operation input received by the user while minimizing interference between the target seat and at least one seat adjacent to the target seat.

### BACKGROUND

As technology advances, various components within a vehicle may be operatively connected to one another. A vehicle control apparatus may quickly and accurately provide various functions by performing cooperative control among components for a user's convenience.

For example, a plurality of seats may be disposed inside a vehicle. A driver's seat and a front passenger's seat may be defined as a first row, seats behind the driver's seat may be defined as a second row, and seats behind the seats in the second row may be defined as a third row.

For example, when a user provides an input (e.g., a switch input) for changing an operating mode of one seat (e.g., a target seat) of a plurality of seats, a situation in which a state of at least one seat adjacent to the target seat needs to be changed along with the target seat may occur.

Nowadays, as functions related to a seat operating mode are applied in various and complex ways, the operation of at least one of a driving device, a control device, or any combination thereof corresponding to at least one adjacent seat as well as a driving device (e.g., a motor) corresponding to the target seat is required to move the target seat. Moreover, in a process of allowing the target seat to be in a specific mode corresponding to a user input, there may be an area or state, in which at least one seat is capable of being moved, to correspond to the type of a specific mode.

According to the prior art, an operating mode of a target seat may be changed based on a relative location between driving devices respectively corresponding to a plurality of seats. However, in this method, an interlocking control amount for at least one adjacent seat may be unnecessarily excessively set to cover a lot of operating modes that have been recently introduced. Furthermore, it is necessary to determine real-time locations of a plurality of seats and a real-time relative location of each driving device. Communication between seats is required to identify a relative location, and excessive communication may occur in this communication process, resulting in a communication load.

### SUMMARY

The present disclosure has been made to solve the above-mentioned problems occurring in the prior art while advantages achieved by the prior art are maintained intact.

Aspects of the present disclosure provide a seat control apparatus and method that identify an operating mode included in an operation input, allow at least one adjacent seat adjacent to a target seat to be in a specified state based on the operating mode, and allow the target seat to be in the operating mode when receiving an operation input to the target seat through an input device.

Aspects of the present disclosure also provide a seat control apparatus and method that control at least one adjacent seat based on a different control amount so as to correspond to each of a plurality of operating modes.

Aspects of the present disclosure also provide a seat control apparatus and method that control a target seat when an operation of at least one adjacent seat is complete, when at least one adjacent seat is no longer working, when a user is not seated in at least one adjacent seat, or after a specified point in time has elapsed since the start of controlling at least one adjacent seat to the specified state, before controlling the target seat in an operating mode.

Aspects of the present disclosure also provide a seat control apparatus and method that determine whether to start controlling the target seat by using a state (e.g., a driving speed, a door state, a collision risk, a user sitting state, or a seat operating state) of the host vehicle in a situation where an operation input is received from the user.

Aspects of the present disclosure also provide a seat control apparatus and method that visually and/or audibly provide the user with information about control of each of a plurality of seats by using a notification device.

The technical problems to be solved by the present disclosure are not limited to the aforementioned problems. Any other technical problems not mentioned herein should be more clearly understood from the following description by those of ordinary skill in the art to which the present disclosure pertains.

According to an aspect of the present disclosure, a seat control apparatus includes an input device, a driving device, a memory that stores instructions, and a control device electrically connected to the input device, the driving device, and the memory. For example, the instructions, when executed by the control device, cause the seat control apparatus to: identify an operating mode included in an operation input when receiving the operation input to a target seat through the input device; identify a specified state of at least one adjacent seat adjacent to the target seat based on the operating mode; allow the at least one adjacent seat to be in the specified state by using the driving device; and allow the target seat to be in the operating mode by using the driving device.

According to an embodiment, the instructions, when executed by the control device, may cause the seat control apparatus, when the operating mode is a relaxation mode, to: forwardly slide a front seat of the target seat among the at least one adjacent seat by a first distance; control a reclining angle of the front seat such that the reclining angle of the front seat is forwardly changed by a 1-1st angle; control a cushion angle of the front seat such that the cushion angle of the front seat is downwardly changed by a 1-2nd angle; and control a reclining angle of a rear seat of the target seat among the at least one adjacent seat such that the reclining angle of the rear seat is changed to a maximum value or a minimum value, by using the driving device. Alternatively, the instructions, when executed by the control device, may cause the seat control apparatus, when the operating mode is a relaxation mode, to backwardly slide the rear seat by the first distance and to control the reclining angle of the rear seat such that the reclining angle of the rear seat is changed to the maximum value or the minimum value, by using the driving device.

According to an embodiment, the instructions, when executed by the control device, may cause the seat control apparatus, when the operating mode is a walk-in mode, to: forwardly slide the front seat by a second distance different from the first distance; control the reclining angle of the front seat such that the reclining angle of the front seat is forwardly changed by a 2-1st angle different from the 1-1st angle; and control the cushion angle of the front seat such that the cushion angle of the front seat is downwardly changed by a 2-2nd angle, by using the driving device.

According to an embodiment, the instructions, when executed by the control device, may cause the seat control apparatus, when the operating mode is a folding mode, to control a reclining angle of a front seat of the target seat among the at least one adjacent seat such that the reclining angle of the front seat is forwardly changed by a third angle, by using the driving device.

According to an embodiment, the instructions, when executed by the control device, may cause the seat control apparatus to allow the target seat to be in the operating mode, based on the at least one adjacent seat completely allowed to be in the specified state.

According to an embodiment, the instructions, when executed by the control device, may cause the seat control apparatus to suspend control of the at least one adjacent seat and the target seat while an operation input is received. Control may be suspended when a speed of a host vehicle is greater than or equal to a predetermined speed, a door of the host vehicle is closed, a risk of collision is detected while the host vehicle is driving, a user is seated in the at least one adjacent seat, or the at least one adjacent seat is operating.

According to an embodiment, the instructions, when executed by the control device, may cause the seat control apparatus to allow the target seat to be in the operating mode when a specified time elapses from a point in time when the at least one adjacent seat starts to be controlled, or when it is identified that the at least one adjacent seat is not moved.

According to an embodiment, a seat control apparatus may further include a notification device. For example, the instructions, when executed by the control device, may cause the seat control apparatus to provide a user with a notification function by using the notification device at at least one of: a first point in time when at least one of the at least one adjacent seat, the target seat, or a combination thereof starts to be controlled; a second point in time when the at least one adjacent seat is completely controlled; a third point in time when it is identified that it is impossible to control the at least one adjacent seat; a fourth point in time when the target seat is completely controlled; or a combination thereof.

According to an embodiment, the instructions, when executed by the control device, may cause the seat control apparatus to change at least one of the on/off of the notification function, a condition of allowing the target seat to be in the operating mode, or a combination thereof, based on settings of the user.

According to an embodiment, the specified state may be set for the at least one adjacent seat adjacent to the target seat in response to the operating mode and may include a boundary section between an allowable state where interference does not occur due to the at least one adjacent seat and an unallowable state where interference occurs, in a process of controlling the target seat.

According to an aspect of the present disclosure, a seat control method includes identifying, by a control device, an operating mode included in an operation input when receiving the operation input to a target seat through an input device. The method also includes identifying, by the control device, a specified state of at least one adjacent seat adjacent to the target seat based on the operating mode. The method also includes allowing, by the control device, the at least one adjacent seat to be in the specified state by using a driving device and allowing, by the control device, the target seat to be in the operating mode by using the driving device.

According to an embodiment, allowing, by the control device, the target seat to be in the operating mode by using the driving device, when the operating mode is a relaxation mode, may further include: forwardly sliding, by the control device, a front seat of the target seat among the at least one adjacent seat by a first distance; controlling a reclining angle of the front seat such that the reclining angle of the front seat is forwardly changed by a 1-1st angle; controlling a cushion angle of the front seat such that the cushion angle of the front seat is downwardly changed by a 1-2nd angle; and controlling a reclining angle of a rear seat of the target seat among the at least one adjacent seat such that the reclining angle of the rear seat is changed to a maximum value or a minimum value, by using the driving device. Alternatively, allowing, by the control device, the target seat to be in the operating mode by using the driving device, when the operating mode is a relaxation mode, may further include backwardly sliding, by the control device, the rear seat by the first distance, and controlling the reclining angle of the rear seat such that the reclining angle of the rear seat is changed to the maximum value or the minimum value, by using the driving device.

According to an embodiment, allowing, by the control device, the target seat to be in the operating mode by using the driving device, when the operating mode is a walk-in mode, may further include: forwardly sliding, by the control device, the front seat by a second distance different from the first distance; controlling the reclining angle of the front seat such that the reclining angle of the front seat is forwardly changed by a 2-1st angle different from the 1-1st angle; and controlling the cushion angle of the front seat such that the cushion angle of the front seat is downwardly changed by a 2-2nd angle, by using the driving device.

According to an embodiment, allowing, by the control device, the target seat to be in the operating mode by using the driving device may include, when the operating mode is a folding mode, controlling, by the control device, a reclining angle of a front seat of the target seat among the at least one adjacent seat such that the reclining angle of the front seat is forwardly changed by a third angle, by using the driving device.

According to an embodiment, allowing, by the control device, the target seat to be in the operating mode by using the driving device may include allowing, by the control device, the target seat to be in the operating mode, based on the at least one adjacent seat completely allowed to be in the specified state.

According to an embodiment, the seat control method may further include suspending, by the control device, control of the at least one adjacent seat and the target seat while an operation input is received, when a speed of a host vehicle is greater than or equal to a predetermined speed, a door of the host vehicle is closed, a risk of collision is detected while the host vehicle is driving, a user is seated in the at least one adjacent seat, or the at least one adjacent seat is operating.

According to an embodiment, allowing, by the control device, the target seat to be in the operating mode by using the driving device may include allowing, by the control device, the target seat to be in the operating mode when a specified time elapses from a point in time when the at least one adjacent seat starts to be controlled, or when it is identified that the at least one adjacent seat is not moved.

According to an embodiment, the seat control method may further include providing, by the control device, a user with a notification function by using a notification device at at least one of: a first point in time when at least one of the at least one adjacent seat, the target seat, or a combination thereof starts to be controlled; a second point in time when the at least one adjacent seat is completely controlled; a third point in time when it is identified that it is impossible to control the at least one adjacent seat; a fourth point in time when the target seat is completely controlled; or a combination thereof.

According to an embodiment, the seat control method may further include changing, by the control device, at least one of on/off of the notification function, a condition of allowing the target seat to be in the operating mode, or a combination thereof, based on settings of the user.

According to an embodiment, the specified state may be set for the at least one adjacent seat adjacent to the target seat in response to the operating mode and may include a boundary section between an allowable state where interference does not occur due to the at least one adjacent seat and an unallowable state where interference occurs, in a process of controlling the target seat.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram showing components of a seat control apparatus, according to an embodiment of the present disclosure;

FIG. 2 is a block diagram showing components of a seat control apparatus, according to an embodiment of the present disclosure;

FIG. 3 is a block diagram showing components of a seat control apparatus, according to an embodiment of the present disclosure;

FIG. 4A is a conceptual diagram of an operation, in which a seat control apparatus allows a target seat to be in a relaxation mode, according to an embodiment of the present disclosure;

FIG. 4B is a conceptual diagram of an operation, in which a seat control apparatus allows a target seat to be in a relaxation mode, according to an embodiment of the present disclosure;

FIG. 5A is a conceptual diagram of an operation, in which a seat control apparatus allows a target seat to be in a walk-in mode, according to an embodiment of the present disclosure;

FIG. 5B is a conceptual diagram of an operation, in which a seat control apparatus allows a target seat to be in a walk-in mode, according to an embodiment of the present disclosure;

FIG. 6A is a conceptual diagram of an operation, in which a seat control apparatus allows a target seat to be in a folding mode, according to an embodiment of the present disclosure;

FIG. 6B is a conceptual diagram of an operation, in which a seat control apparatus allows a target seat to be in a folding mode, according to an embodiment of the present disclosure;

FIG. 7 is a flowchart illustrating an operation of a seat control apparatus, according to an embodiment of the present disclosure;

FIG. 8 is a flowchart illustrating an operation of a seat control apparatus, according to an embodiment of the present disclosure;

FIG. 9 is a flowchart illustrating an operation of a seat control apparatus, according to an embodiment of the present disclosure;

FIG. 10 is a flowchart illustrating an operation of a seat control apparatus, according to an embodiment of the present disclosure; and

FIG. 11 illustrates a computing system related to a seat control method, according to an embodiment of the present disclosure.

With regard to the descriptions of the drawings, the same or similar components are marked by the same or similar reference signs throughout the drawings.

### DETAILED DESCRIPTION

Hereinafter, some embodiments of the present disclosure are described in detail with reference to the accompanying drawings. In adding reference numerals to components of each drawing, it should be noted that the same components have the same reference numerals, although they are indicated on another drawing. Furthermore, in describing embodiments of the present disclosure, detailed descriptions associated with well-known functions or configurations have been omitted where they may have made subject matter of the present disclosure unnecessarily obscure.

In describing elements of an embodiment of the present disclosure, the terms first, second, A, B, (a), (b), and the like may be used herein. These terms are only used to distinguish one element from another element but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It should be understood that terms used herein should be interpreted as having a meaning that is consistent with their meaning in the context of the present disclosure and the relevant art and should not be interpreted in an idealized or overly formal sense unless expressly so defined herein.

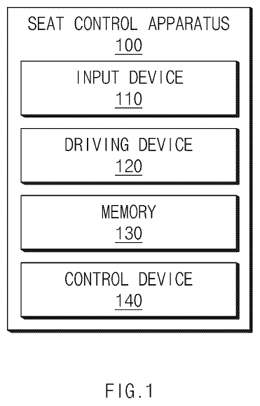

Hereinafter, various embodiments of the present disclosure are described in detail with reference to FIGS. 1-11. When a component, device, element, or the like of the present disclosure is described as having a purpose or performing an operation, function, or the like, the component, device, or element should be considered herein as being “configured to” meet that purpose or to perform that operation or function.

FIG. 1 is a block diagram showing components of a seat control apparatus, according to an embodiment of the present disclosure.

According to an embodiment, a seat control apparatus 100 may include at least one of an input device 110, a driving device 120, a memory 130, a control device 140, or any combination thereof.

According to an embodiment, the input device 110 may include at least one input device. For example, the input device 110 may include a switch. For example, the input device 110 may include a switch module including a plurality of structures related to an operating mode of a seat. For example, the input device 110 may include a plurality of input devices (or switches) respectively corresponding to a plurality of seats included in the host vehicle. For example, at least part of the input devices included in the input device 110 may be implemented in a form of a touch screen.

For example, the input device 110 may receive an operation input from a user. For example, the input device 110 may receive an operation input including a user's pressure input and/or touch input.

For example, when the user provides an operation input (e.g., a pressure input and/or a touch input) to at least one button (or a specified area) included in the input device 110, the control device 140 may identify an operating mode included in an operation input. For example, the control device 140 may identify an operating mode based on at least one of a button for receiving an input from the user among the at least one button included in the input device 110, the magnitude of the operation input, a direction of the operation input, an input location of the operation input, or any combination thereof.

According to an embodiment, the driving device 120 may include at least one of a motor, an engine, or any combination thereof.

For example, the driving device 120 may change a location (or state) of at least part of a plurality of seats provided in the host vehicle based on a control signal delivered from the control device 140.

For example, the driving device 120 may include at least one of a plurality of motors, a plurality of actuators, a plurality of gears, or any combination thereof, which correspond to a plurality of seats, respectively.

According to an embodiment, the memory 130 may store instructions or data. For example, the memory 130 may store one or more instructions that cause the seat control apparatus 100 to perform various operations when executed by the control device 140.

For example, the memory 130 and the control device 140 may be implemented as one chipset. The control device 140 may include at least one of a communication processor or a modem.

For example, the memory 130 may store various pieces of information related to the seat control apparatus 100.

For example, the memory 130 may store information about an operation history of the control device 140.

For example, the memory 130 may store information related to states and/or operations of components (e.g., at least one of an engine control unit (ECU), the input device 110, the driving device 120, the control device 140, or any combination thereof) of the host vehicle.

For example, the memory 130 may store a specified state (or mode) set by a user for each of a plurality of seats and a state of the driving device 120 of each of the plurality of seats corresponding to the specified state.

According to an embodiment, the control device 140 may be operatively connected to at least one of the input device 110, the driving device 120, the memory 130, or any combination thereof. For example, the control device 140 may control an operation of at least one of the input device 110, the driving device 120, the memory 130, or any combination thereof.

For example, when receiving an operation input to the target seat through the input device 110, the control device 140 may identify an operating mode included in the operation input.

For example, the control device 140 may receive the operation input provided by the user through the input device 110. For example, the operation input may be received by an input device corresponding to a target seat among a plurality of input devices (e.g., switches) included in the input device 110. The operation input may include, for example, a control signal for changing an operating mode (or an operating state) of the target seat to match the user's intent. The operation input may include, for example, at least one operating mode (e.g., a normal mode, a relaxation mode, a walk-in mode, or a folding mode) for a target seat. For example, a relaxation mode may be defined as a combination of “relax”, which means that the user relaxes, and “position”, which means the posture of the seat. For example, a relaxation mode may refer to an operation mode (or state) of a seat implemented so that the user may sit relatively comfortably and rest.

For example, the control device 140 may identify a specified state of at least one seat adjacent to the target seat based on the identified operating mode.

For example, the specified state may include at least one of slide information of at least one adjacent seat, reclining information of the at least one adjacent seat, folding information of the at least one adjacent seat, or any combination thereof to prevent interference caused by the at least one adjacent seat in a process of moving (or transitioning) the target seat from a current state to the operating mode.

For example, the memory 130 may store information about a specified state of at least one adjacent seat corresponding to at least one operating mode. For example, the control device 140 may identify the specified state of the at least one adjacent seat based on the information about the specified state stored in the memory 130.

For example, the control device 140 may allow at least one adjacent seat to be in a specified state identified to correspond to the operating mode of the target seat.

For example, when the operating mode is a relaxation mode, the control device 140 may forwardly slide a front seat of the target seat from the target seat by a first distance (e.g., 100 mm) by using the driving device 120.

For example, when the operating mode is the relaxation mode, the control device 140 may control a reclining angle of the front seat of the target seat such that the reclining angle is forwardly changed by a 1-1st angle (e.g., 10 degrees) by using the driving device 120.

For example, when the operating mode is the relaxation mode, the control device 140 may control a cushion angle of the front seat of the target seat such that the cushion angle is downwardly changed by a 1-2nd angle (e.g., 8 degrees) by using the driving device 120.

For example, when the operating mode is the relaxation mode, the control device 140 may control a reclining angle of a rear seat of the target seat to a maximum value or a minimum value by using the driving device 120. In other words, the rear seat may be reclined at the maximum angle or the minimum angle.

The above-described example is an embodiment in which it is assumed that the target seat is located in the second row when the host vehicle includes a total of three rows of seats. Embodiments of the present disclosure are not limited thereto.

For example, when the target seat is the first-row seat, there is no front seat. Accordingly, the control device 140 may control only the rear seat by using the driving device 120. For example, when the target seat is the first-row seat, the control device 140 may backwardly slide the rear seat by a first distance by using the driving device 120. For example, when the target seat is the first-row seat, the control device 140 may control a reclining angle of the rear seat to a maximum value or a minimum value by using the driving device 120. The above-described embodiment is also an example. When the target seat is the first-row seat, the control device 140 may additionally or alternatively adjust a cushion angle of the rear seat by using the driving device 120. In other words, the state of the rear seat may be controlled to prevent interference from the rear seat in a process of transitioning the target seat to the relaxation mode.

For example, when the operating mode is a walk-in mode, the control device 140 may forwardly move a front seat of the target seat from the target seat by a second distance (e.g., 20 mm) by using the driving device 120. The second distance may be different from the first distance. For example, the second distance may be smaller than the first distance.

For example, when the operating mode is the walk-in mode, the control device 140 may control a reclining angle of the front seat of the target seat such that the reclining angle is forwardly changed by a 2-1st angle (e.g., 18 degrees) by using the driving device 120. The 2-1st angle may be different from a 1-1st angle. For example, the 2-1st angle may be greater than the 1-1st angle.

For example, when the operating mode is the walk-in mode, the control device 140 may control a cushion angle of the front seat of the target seat such that the cushion angle is downwardly changed by a 2-2nd angle (e.g., 8 degrees) by using the driving device 120.

For example, when the operating mode is a folding mode, the control device 140 may control a reclining angle of the front seat of the target seat such that the reclining angle is forwardly changed by a third angle (e.g., 12 degrees) by using the driving device 120. For example, the third angle may be greater than the 1-1st angle and may be smaller than the 2-1st angle.

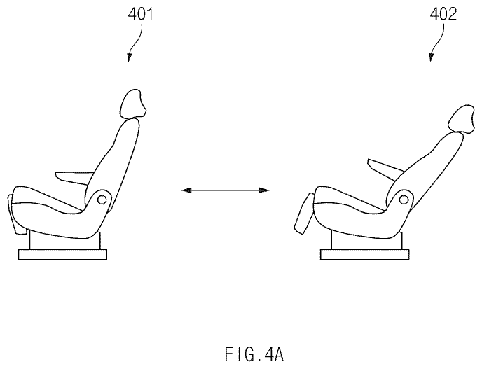

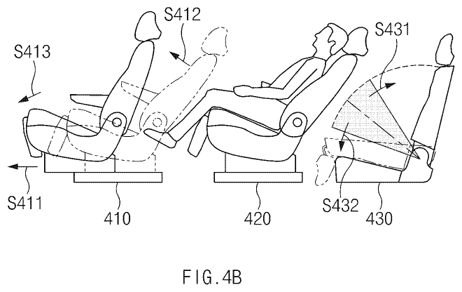

A method of controlling a target seat and at least one adjacent seat according to an operating mode may be described in more detail with reference to FIGS. 4A-6B below. Moreover, an example of the control amount (or a movement amount) and a control target seat for each of a plurality of seats is a simple numerical example, and embodiments of the present disclosure are not limited thereto.

For example, the control device 140 may allow the target seat to be in an operating mode by using the driving device 120.

For example, the control device 140 may allow the target seat to be in an operating mode based on (or in response to) at least one adjacent seat completely allowed to be in the specified state. In other words, after allowing at least one adjacent seat to be in the specified state corresponding to the operating mode of the target seat, the control device 140 may start allowing the target seat to be in the operating mode.

For example, when the specified time elapses from the start of control of at least one adjacent seat, or when it is identified that at least one adjacent seat does not move, the control device 140 may start allowing the target seat to be in the operating mode. In other words, when the specified time (e.g., 2 seconds) has elapsed since the start of allowing at least one adjacent seat to be in the specified state, or when it is identified that at least one adjacent seat is no longer moved, the control device 140 may start allowing the target seat to be in the operating mode.

For example, the control device 140 may change a condition for allowing the target seat to be in the operating mode based on the user's settings.

For example, when the control device 140 starts controlling the target seat based on at least one adjacent seat completely allowed to be in a specified state, when the control device 140 starts controlling the target seat after the specified time elapses from a point in time when the control of at least one adjacent seat is started, or when it is identified that at least one adjacent seat is no longer moved, the control device 140 may start allowing the target seat to be in the operating mode based on the user's setting.

For example, the control device 140 may determine whether to suspend the control of the target seat, based on at least one of the state of the host vehicle, the driving situation of the host vehicle, the seat state of the host vehicle, or any combination thereof.

For example, when the driving speed of the host vehicle is greater than or equal to a predetermined speed, when a door of the host vehicle is closed, when a risk of collision is detected while the host vehicle is driving, when a user is seated in a part of at least one adjacent seat, or when the at least one adjacent seat is operating (or moving), the control device 140 may suspend control of the at least one adjacent seat and/or the target seat while receiving an operation input from the user.

For example, when the door of the host vehicle corresponding to the target seat is closed while the control device 140 receives an operation input, the control device 140 may suspend control of the target seat.

The configuration of the seat control apparatus 100 shown in FIG. 1 is an example. Embodiments of the present disclosure are not limited thereto.

In an embodiment, the seat control apparatus 100 may further include a sensor device (not shown).

For example, the seat control apparatus 100 may identify at least one seat in which a user is sitting, from among a plurality of seats in the host vehicle by using a sensor device. For example, the seat control apparatus 100 may identify a current state (e.g., at least one of a slide state, a reclining state, a folding state, or any combination thereof) of each of the plurality of seats in the host vehicle by using the sensor device.

In an embodiment, the seat control apparatus 100 may further include a communication device (not shown).

For example, the communication device may establish a communication channel (e.g., wireless communication channel) between the seat control apparatus 100 and an external device (e.g., a micro control unit (MCU) and/or an electric control unit (ECU)) and may support communication through the established communication channel. For example, the communication device may include one or more communication processors which are operated independently of the control device 140 (e.g., an application processor) and support direct (or wired) communication or wireless communication.

For example, the communication device may include a wireless communication module (e.g., a cellular communication module, a short-range wireless communication module, or a global navigation satellite system (GNSS) communication module) or a wired communication module (e.g., a controller area network (CAN) communication module, a local area network (LAN) communication module, or a power line communication module). The corresponding communication module among these communication modules may communicate with an external device through a first network (e.g., a short-range communication network such as Bluetooth, wireless fidelity (WiFi) direct or infrared data association (IrDA)) or a second network (e.g., a legacy cellular network, 5G networks, next-generation communication networks, Internet, or telecommunication networks such as computer networks (e.g., LAN or WAN)) included in a network. The above-described kinds of communication modules may be integrated in one component (e.g., a single chip) or may be implemented with a plurality of components (e.g., a plurality of chips) which are independent of each other. Also, the communication device and the control device 140 may be implemented as a single chip.

In an embodiment, the seat control apparatus 100 may further include a notification device (not shown).

For example, the notification device may include at least one output device. For example, the notification device may include an output device (e.g., at least one of a speaker, an amplifier, a buzzer, a display, or any combination thereof) included in at least part of the interior of the host vehicle.

For example, the notification device may output various types of sound to the outside.

For example, the notification device may provide the user with a notification function for a seat control situation under control of the control device 140.

For example, the notification device may provide the user with the notification function at at least one of: a point in time when at least one of at least one adjacent seat, the target seat, or any combination thereof starts to be controlled; a point in time when at least one adjacent seat is completely controlled; a point in time when it is identified that it is impossible to control at least one adjacent seat; a point in time when the target seat is completely controlled; or any combination thereof.

For example, while at least part of a plurality of seats moves under control of the control device 140, the notification device may continuously provide the user with a notification function.

For example, the notification device may provide the user with a notification function in at least part of the above-mentioned time points or sections according to user settings.

For example, the notification device may turn on/off an operation of providing the notification function in at least part of the above-described time points or sections according to user settings.

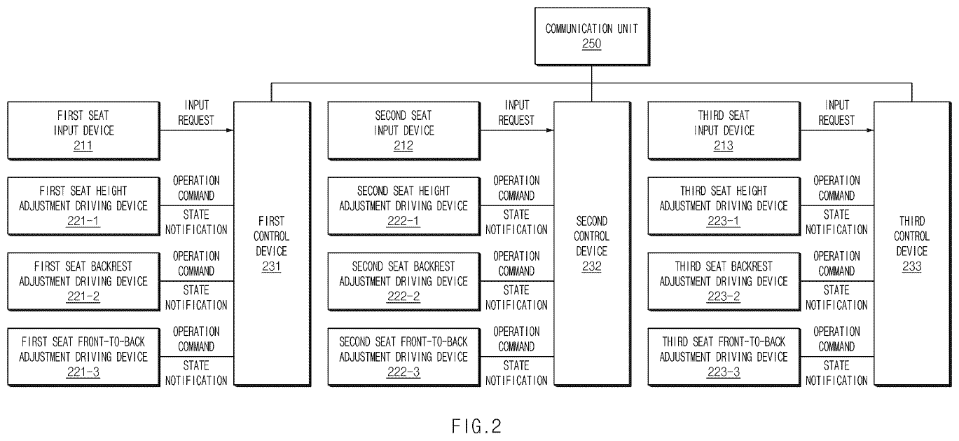

FIG. 2 is a block diagram showing components of a seat control apparatus, according to an embodiment of the present disclosure.

According to an embodiment, a seat control apparatus (e.g., the seat control apparatus 100 in FIG. 1) may include an input device (e.g., the input device 110 of FIG. 1), a driving device (e.g., the driving device 120 of FIG. 1), and a control device (e.g., the control device 140 of FIG. 1).

According to an embodiment, the seat control apparatus may include an input device, a driving device, and a control device corresponding to each of a plurality of seats.

According to an embodiment, the seat control apparatus may include a plurality of input devices (e.g., a first seat input device 211, a second seat input device 212, and a third seat input device 213) included in the input device of FIG. 1.

For example, the first seat input device 211, the second seat input device 212, and the third seat input device 213 may be input devices corresponding to a first seat, a second seat, and a third seat, respectively.

According to an embodiment, the seat control apparatus may include a plurality of driving devices included in the driving device of FIG. 1.

For example, the seat control apparatus may include a first seat height adjustment driving device 221-1, a first seat backrest adjustment driving device 221-2, and a first seat front-to-back adjustment driving device 221-3, which correspond to a first seat.

For example, the seat control apparatus may include a second seat height adjustment driving device 222-2, a second seat backrest adjustment driving device 222-2, and a second seat front-to-back adjustment driving device 222-3, which correspond to a second seat.

For example, the seat control apparatus may include a third seat height adjustment driving device 223-3, a third seat backrest adjustment driving device 223-2, and a third seat front-to-back adjustment driving device 223-3, which correspond to a third seat.

For example, the height adjustment driving device may include at least one driving device that controls the height including a cushion angle of a seat.

For example, the backrest adjustment driving device may include at least one driving device that controls a backrest angle including a reclining angle of a seat.

For example, the front-to-back adjustment driving device may include at least one driving device that controls front and rear locations including a slide location of the seat.

According to an embodiment, the seat control apparatus may include a plurality of control devices included in the control device of FIG. 1.

For example, a first control device 231, a second control device 232, and a third control device 233 may be control devices corresponding to the first seat, the second seat, and the third seat, respectively.

According to an embodiment, the first control device 231, the second control device 232, and the third control device 233 may be operatively connected to a communication device 250. For example, the first control device 231, the second control device 232, and the third control device 233 may deliver an operation command (or a control signal) to a driving device in response to an input request (or an operation input) received through an input device, may receive a state notification about states of a plurality of seats controlled in response to the operation command from the driving device, and may exchange communication data, which is exchanged with the input device and the driving device, with the communication device 250.

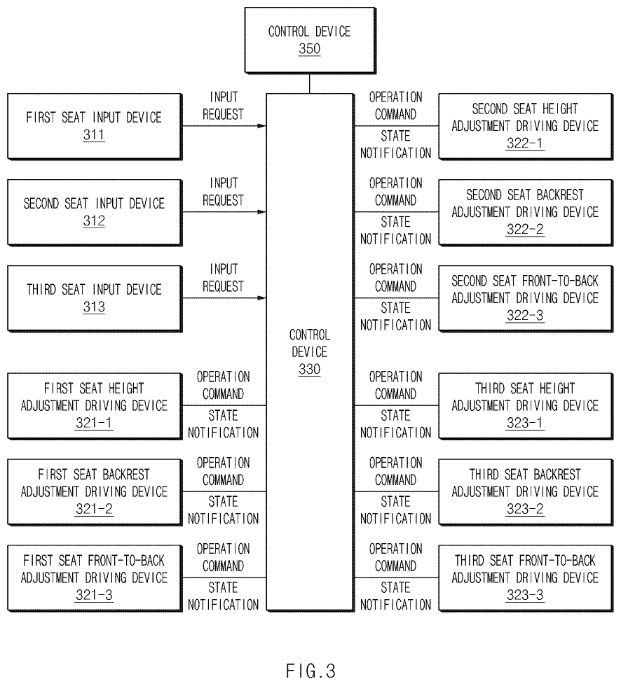

FIG. 3 is a block diagram showing components of a seat control apparatus, according to an embodiment of the present disclosure.

According to an embodiment, a seat control apparatus (e.g., the seat control apparatus 100 in FIG. 1) may include an input device (e.g., the input device 110 of FIG. 1), a driving device (e.g., the driving device 120 of FIG. 1), and a control device 330 (e.g., the control device 140 of FIG. 1).

According to an embodiment, the seat control apparatus may include an input device and a driving device corresponding to each of a plurality of seats.

Unlike an embodiment in FIG. 2, according to an embodiment of FIG. 3, the seat control apparatus may include one control device 330 that integrally controls the plurality of seats.

According to an embodiment, the seat control apparatus may include a plurality of input devices (e.g., a first seat input device 311, a second seat input device 312, and a third seat input device 313) included in the input device of FIG. 1.

For example, the first seat input device 311, the second seat input device 312, and the third seat input device 313 may be input devices corresponding to a first seat, a second seat, and a third seat, respectively.

According to an embodiment, the seat control apparatus may include a plurality of driving devices included in the driving device of FIG. 1.

For example, the seat control apparatus may include a first seat height adjustment driving device 321-1, a first seat backrest adjustment driving device 321-2, and a first seat front-to-back adjustment driving device 321-3, which correspond to a first seat.

For example, the seat control apparatus may include a second seat height adjustment driving device 322-2, a second seat backrest adjustment driving device 322-2, and a second seat front-to-back adjustment driving device 322-3, which correspond to a second seat.

For example, the seat control apparatus may include a third seat height adjustment driving device 323-3, a third seat backrest adjustment driving device 323-2, and a third seat front-to-back adjustment driving device 323-3, which correspond to a third seat.

For example, the height adjustment driving device may include at least one driving device that controls the height including a cushion angle of a seat.

For example, the backrest adjustment driving device may include at least one driving device that controls a backrest angle including a reclining angle of a seat.

For example, the front-to-back adjustment driving device may include at least one driving device that controls front and rear locations including a slide location of the seat.

According to an embodiment, the seat control apparatus may include the control device 330 operatively connected to a plurality of input devices and a plurality of driving devices.

For example, the control device 330 may be a component that integrally controls a plurality of seats in a host vehicle including a first seat, a second seat, and a third seat.

According to an embodiment, the control device 330 may be operatively connected to the communication device 350. For example, the control device 330 may deliver an operation command (or a control signal) to a driving device in response to an input request (or an operation input) received through an input device, may receive a state notification about states of a plurality of seats controlled in response to the operation command from the driving device, and may exchange communication data, which is exchanged with the input device and the driving device, with the communication device 350.

FIG. 4A is a conceptual diagram of an operation, in which a seat control apparatus allows a target seat to be in a relaxation mode, according to an embodiment of the present disclosure. For example, a relaxation mode may be defined as a combination of “relax”, which means that the user relaxes, and “position”, which means the posture of the seat. For example, a relaxation mode may refer to an operation mode (or state) of a seat implemented so that the user may sit relatively comfortably and rest.

According to an embodiment, a seat control apparatus (e.g., the seat control apparatus 100 of FIG. 1) may control states of at least some seats among a plurality of seats included in a host vehicle.

Referring to reference number 401, according to an embodiment, in a situation where the target seat is operating in a normal mode, the seat control apparatus may receive an operation input related to an operating mode change of the target seat from a user.

For example, the seat control apparatus may receive an operation input for the target seat from the user through an input device (e.g., the input device 110 in FIG. 1) corresponding to the target seat. The operation input according to FIG. 4A may include a signal for requesting control of the target seat such that the target seat is in a relaxation mode. The seat control apparatus may allow at least one adjacent seat adjacent to the target seat to be in a specified state based on receiving the operation input by using a driving device (e.g., the driving device 120 in FIG. 1), and may allow the target seat to be in the relaxation mode.

Referring to reference number 402, according to an embodiment, the seat control apparatus may control the target seat such that a mode the target seat is changed from the normal mode to the relaxation mode.

For example, compared to the normal mode according to reference number 401, the relaxation mode according to reference number 402 may be defined as a state where a cushion angle upwardly moves by a specified cushion control angle and a reclining angle backwardly moves by a specified reclining control angle.

FIG. 4B is a conceptual diagram of an operation, in which a seat control apparatus allows a target seat to be in a relaxation mode, according to an embodiment of the present disclosure.

According to an embodiment, a seat control apparatus (e.g., the seat control apparatus 100 in FIG. 1) may control the operating mode of at least one of a target seat 420, at least one adjacent seat 410 or 430 adjacent to the target seat 420, or any combination thereof.

For example, the seat control apparatus may receive an operation input including a relaxation mode from a user through an input device (e.g., the input device 110 in FIG. 1).

For example, the seat control apparatus may identify a specified state of the at least one adjacent seat 410 or 430 corresponding to the relaxation mode and may allow the at least one adjacent seat 410 or 430 to be in a specified state.

For example, the specified state may be set for the at least one adjacent seat 410 or 430 adjacent to the target seat 420 in response to the operating mode to move (or control) the target seat 420 such that the target seat 420 is in a specific mode, and may include a boundary section between an allowable state where interference does not occur due to the at least one adjacent seat 410 or 430 and an unallowable state where interference occurs, in a process of controlling the target seat 420.

Referring to reference number S411, for example, the seat control apparatus may forwardly slide the front seat 410 of the target seat 420 by a first distance (e.g., 100 mm) among the at least one adjacent seat 410 or 430 by using a driving device (e.g., the driving device 120 in FIG. 1).

Referring to reference number S412, for example, the seat control apparatus may control a reclining angle of the front seat 410 such that the reclining angle is forwardly changed by a 1-1st angle (e.g., 10 degrees) by using the driving device.

Referring to reference number S413, for example, the seat control apparatus may control a cushion angle of the front seat 410 such that the cushion angle is downwardly changed by a 1-2nd angle (e.g., 8 degrees) by using the driving device.

Referring to reference numbers S431 and S432, for example, the seat control apparatus may control a reclining angle of the rear seat 430 of the target seat 420 among the at least one adjacent seat 410 or 430 such that the reclining angle is changed to a maximum value or a minimum value by using a driving device.

For example, referring to reference number S431, the seat control apparatus may control the reclining angle of the rear seat 430 such that the reclining angle of the rear seat 430 is changed to the maximum value.

For example, according to reference number S432, the seat control apparatus may control the reclining angle of the rear seat 430 such that the reclining angle of the rear seat 430 is changed to the minimum value.

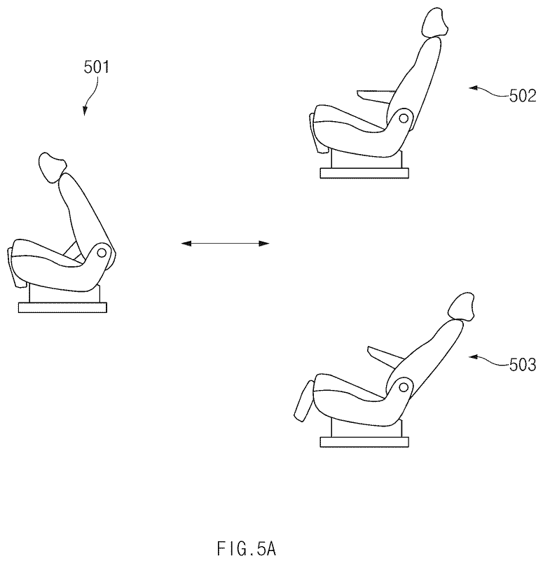

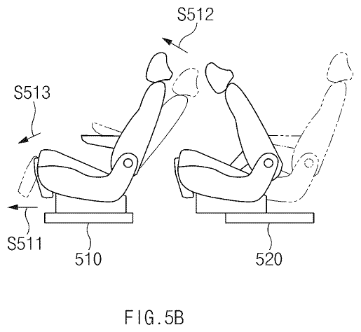

FIG. 5A is a conceptual diagram of an operation, in which a seat control apparatus allows a target seat to be in a walk-in mode, according to an embodiment of the present disclosure.

According to an embodiment, a seat control apparatus (e.g., the seat control apparatus 100 of FIG. 1) may control states of at least some seats among a plurality of seats included in a host vehicle.

Referring to reference number 501, according to an embodiment, in a situation where the target seat is operating in a walk-in mode, the seat control apparatus may receive an operation input related to an operating mode change of the target seat from a user.

For example, the seat control apparatus may receive an operation input for the target seat from the user through an input device (e.g., the input device 110 in FIG. 1) corresponding to the target seat. The operation input according to FIG. 5A may include a signal for requesting control of the target seat such that a mode of the target seat is changed from a walk-in mode to a normal mode. The description of the operation input and the operation algorithm is an example. The seat control apparatus may receive an operation input, which allows the target seat to be in the walk-in mode according to reference number 501, from the user in a situation (e.g., a normal mode) where the target seat corresponds to reference number 502.

The seat control apparatus may allow at least one adjacent seat adjacent to the target seat to be in a specified state based on receiving the operation input by using a driving device (e.g., the driving device 120 in FIG. 1), and may allow the target seat to be in the normal mode according to reference number 502 and/or in the walk-in mode according to reference number 501.

Referring to reference number 503, according to an embodiment, the seat control apparatus may control the target seat such that a mode the target seat is changed from the walk-in mode to the relaxation mode.

For example, the relaxation mode according to reference number 503 may be defined as an operating mode substantially the same as the relaxation mode according to reference number 402 of FIG. 4A described above.

For example, the seat control apparatus may change an operating mode between the relaxation mode and the walk-in mode according to the user's settings based on receiving one operation input.

FIG. 5B is a conceptual diagram of an operation, in which a seat control apparatus allows a target seat to be in a walk-in mode, according to an embodiment of the present disclosure.

According to an embodiment, a seat control apparatus (e.g., the seat control apparatus 100 in FIG. 1) may control the operating mode of at least one of a target seat 520, at least one adjacent seat (e.g., a front seat 510) adjacent to the target seat 520, or any combination thereof.

For example, the seat control apparatus may receive an operation input including a walk-in mode from a user through an input device (e.g., the input device 110 in FIG. 1).

For example, the seat control apparatus may identify a specified state of the at least one adjacent seat corresponding to the walk-in mode and may allow the at least one adjacent seat to be in a specified state.

For example, the specified state may be set for the at least one adjacent seat adjacent to the target seat 520 in response to the operating mode to move (or control) the target seat 520 such that the target seat 520 is in a specific mode, and may include a boundary section between an allowable state where interference does not occur due to the at least one adjacent seat and an unallowable state where interference occurs, in a process of controlling the target seat 520.

Referring to reference number S511, for example, the seat control apparatus may forwardly slide the front seat 510 of the target seat 520 by a second distance (e.g., 20 mm) among the at least one adjacent seat by using a driving device (e.g., the driving device 120 in FIG. 1). For example, the second distance may be smaller than the first distance according to FIG. 4B.

Referring to reference number S512, for example, the seat control apparatus may control a reclining angle of the seat 510 such that the reclining angle is forwardly changed by a 2-1st angle (e.g., 18 degrees) by using the driving device. For example, the 2-1st angle may be greater than the 1-1st angle according to FIG. 4B.

Referring to reference number S513, for example, the seat control apparatus may control a cushion angle of the front seat 510 such that the cushion angle is downwardly changed by a 2-2nd angle (e.g., 8 degrees) by using the driving device.

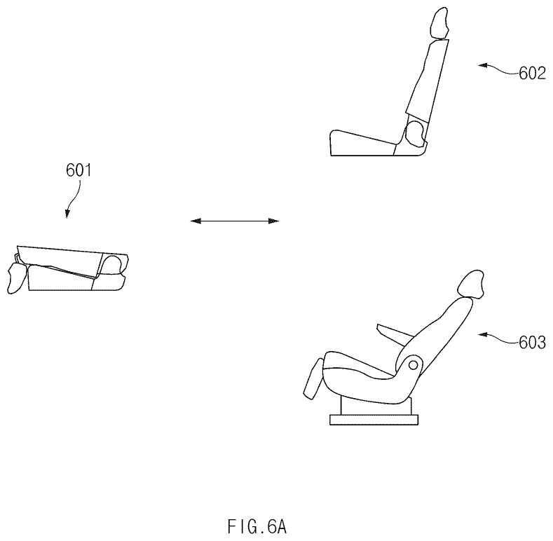

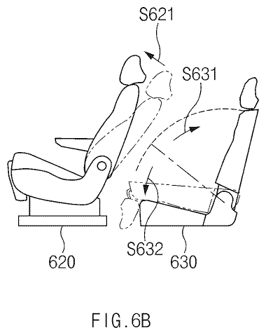

FIG. 6A is a conceptual diagram of an operation, in which a seat control apparatus allows a target seat to be in a folding mode, according to an embodiment of the present disclosure.

According to an embodiment, a seat control apparatus (e.g., the seat control apparatus 100 of FIG. 1) may control states of at least some seats among a plurality of seats included in a host vehicle.

Referring to reference number 601, according to an embodiment, in a situation where the target seat is operating in a folding mode, the seat control apparatus may receive an operation input related to an operating mode change of the target seat from a user.

For example, the seat control apparatus may receive an operation input for the target seat from the user through an input device (e.g., the input device 110 in FIG. 1) corresponding to the target seat. The operation input according to FIG. 6A may include a signal for requesting control of the target seat such that a mode of the target seat is changed from the folding mode to a normal mode. The description of the operation input and the operation algorithm is an example. The seat control apparatus may receive an operation input, which allows the target seat to be in the folding mode according to reference number 601, from the user in a situation (e.g., a normal mode) where the target seat corresponds to reference number 602.

The seat control apparatus may allow at least one adjacent seat adjacent to the target seat to be in a specified state based on receiving the operation input by using a driving device (e.g., the driving device 120 in FIG. 1), and may allow the target seat to be in the normal mode according to reference number 602 and/or in the folding mode according to reference number 601.

Referring to reference number 603, according to an embodiment, the seat control apparatus may control the target seat such that a mode the target seat is changed from the folding mode to a relaxation mode.

For example, the relaxation mode according to reference number 603 may be defined as an operating mode substantially the same as the relaxation mode according to reference number 402 of FIG. 4A and reference number 503 of FIG. 5A described above.

For example, the seat control apparatus may change an operating mode between the relaxation mode and the folding mode according to the user's settings based on receiving one operation input.

FIG. 6B is a conceptual diagram of an operation, in which a seat control apparatus allows a target seat to be in a folding mode, according to an embodiment of the present disclosure.

According to an embodiment, a seat control apparatus (e.g., the seat control apparatus 100 in FIG. 1) may control the operating mode of at least one of a target seat 630, at least one adjacent seat (e.g., a front seat 620) adjacent to the target seat 630, or any combination thereof.

For example, the seat control apparatus may receive an operation input including a folding mode from a user through an input device (e.g., the input device 110 in FIG. 1).

For example, the seat control apparatus may identify a specified state of the at least one adjacent seat corresponding to the folding mode and may allow the at least one adjacent seat to be in a specified state.

For example, the specified state may be set for the at least one adjacent seat adjacent to the target seat 630 in response to the operating mode to move (or control) the target seat 630 such that the target seat 630 is in a specific mode, and may include a boundary section between an allowable state where interference does not occur due to the at least one adjacent seat and an unallowable state where interference occurs, in a process of controlling the target seat 520.

Referring to reference number S621, for example, the seat control apparatus may forwardly slide a reclining angle of the front seat 620 of the target seat 630 by a third distance (e.g., 12 mm) among the at least one adjacent seat by using a driving device (e.g., the driving device 120 in FIG. 1).

Referring to reference number S631, for example, the seat control apparatus may implement an unfolding mode of the target seat 630 by controlling the reclining angle of the target seat 630 such that the reclining angle of the target seat 630 is changed to a maximum value by using the driving device.

Referring to reference number S632, for example, the seat control apparatus may implement the folding mode of the target seat 630 by controlling the reclining angle of the target seat 630 such that the reclining angle of the target seat 630 is changed to a minimum value by using the driving device.

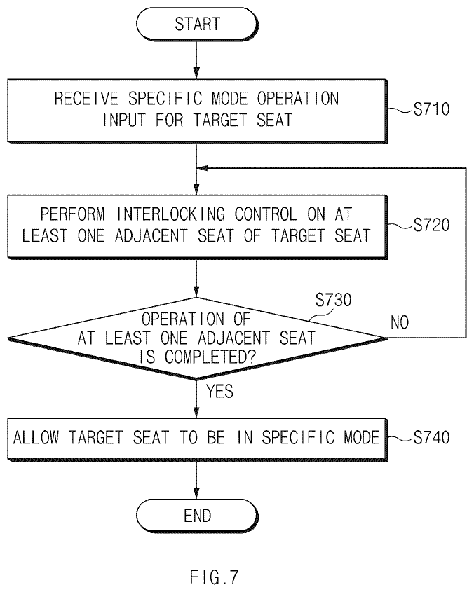

FIG. 7 is a flowchart illustrating an operation of a seat control apparatus, according to an embodiment of the present disclosure.

According to an embodiment, a seat control apparatus (e.g., the seat control apparatus 100 of FIG. 1) may perform operations described in FIG. 7. For example, at least some of the components (e.g., the input device 110, the driving device 120, the memory 130, and/or the control device 140 of FIG. 1) included in the seat control apparatus may be configured to perform the operations of FIG. 7.

In the following embodiment, operation S710 to operation S740 may be sequentially performed, but are not always performed sequentially. For example, the order of operations may be changed, and at least two operations may be performed in parallel. Moreover, descriptions corresponding to or identical to the above-mentioned descriptions given with reference to FIG. 7 may be briefly described or omitted to avoid redundancy.

According to an embodiment, the seat control apparatus may receive a specific mode of operation input for a target seat (S710).

For example, the seat control apparatus may receive an operation input including a request signal for requesting control of a target seat such that the target seat is in a specific mode (or an operating mode), from a user through an input device.

For example, the specific mode may include at least one of a normal mode, a relaxation mode, a walk-in mode, a folding mode, or any combination thereof.

According to an embodiment, the seat control apparatus may perform interlocking control on at least one adjacent seat of the target seat (S720).

For example, the seat control apparatus may identify an operating mode included in the operation input, may identify a specified state of the at least one adjacent seat corresponding to the operating mode, and may control the at least one adjacent seat such that the at least one adjacent seat interlocks with a specified state.

According to an embodiment, the seat control apparatus may determine whether an operation of the at least one adjacent seat is completed (S730).

For example, when the operation of at least one adjacent seat is not completed (e.g., operation S730—No), the seat control apparatus may perform operation S720.

For example, when the operation of at least one adjacent seat is completed (e.g., operation S730—Yes), the seat control apparatus may perform operation S740.

According to an embodiment, the seat control apparatus may allow the target seat to be in a specific mode (S740).

For example, the seat control apparatus may allow the target seat to be in an operating mode included in the operation input, based on the at least one adjacent seat completely operating in the specified state.

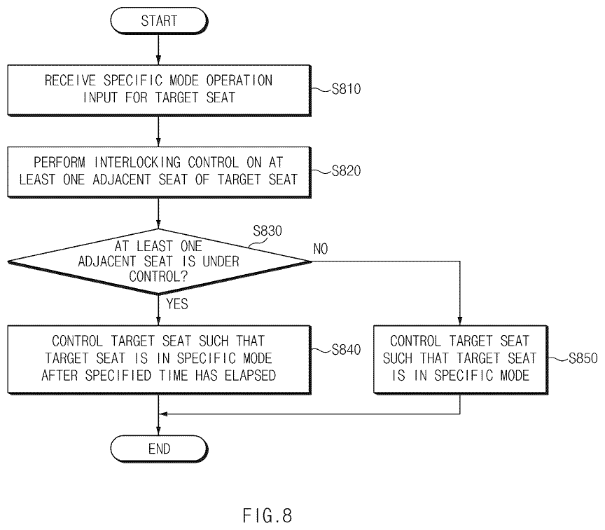

FIG. 8 is a flowchart illustrating an operation of a seat control apparatus, according to an embodiment of the present disclosure.

According to an embodiment, a seat control apparatus (e.g., the seat control apparatus 100 of FIG. 1) may perform operations described in FIG. 8. For example, at least some of components (e.g., the input device 110, the driving device 120, the memory 130, and/or the control device 140 of FIG. 1) included in the seat control apparatus may be configured to perform the operations of FIG. 8.

In the following embodiment, operation S810 to operation S850 may be sequentially performed, but are not always performed sequentially. For example, the order of operations may be changed, and at least two operations may be performed in parallel. Moreover, descriptions corresponding to or identical to the above-mentioned descriptions given with reference to FIG. 8 may be briefly described or omitted to avoid redundancy.

According to an embodiment, the seat control apparatus may receive a specific mode of operation input for a target seat (S810).

For example, the seat control apparatus may receive an operation input including a request signal for requesting control of a target seat such that the target seat is in a specific mode (or an operating mode), from a user through an input device.

For example, the specific mode may include at least one of a normal mode, a relaxation mode, a walk-in mode, a folding mode, or any combination thereof.

According to an embodiment, the seat control apparatus may perform interlocking control on at least one adjacent seat of the target seat (S820).

For example, the seat control apparatus may identify an operating mode included in the operation input, may identify a specified state of the at least one adjacent seat corresponding to the operating mode, and may control the at least one adjacent seat such that the at least one adjacent seat interlocks with a specified state.

According to an embodiment, the seat control apparatus may determine whether at least one adjacent seat is under control (S830).

For example, when the at least one adjacent seat is under control (e.g., operation S830—Yes), the seat control apparatus may perform operation S840.

For example, when the at least one adjacent seat is not under control (e.g., operation S830—No), the seat control apparatus may perform operation S850.

According to an embodiment, the seat control apparatus may start controlling the target seat such that the target seat is in a specific mode after a specified time (e.g., 2 seconds) has elapsed (S840).

For example, the seat control apparatus may start controlling the target seat such that the target seat is in the specific mode after the specified time has elapsed from the start of interlocking control of at least one adjacent seat.

According to an embodiment, the seat control apparatus may start controlling the target seat such that the target seat is in the specific mode (S850).

For example, when the at least one adjacent seat is not under control, the seat control apparatus may identify that at least one adjacent seat has been controlled and may start controlling the target seat such that the target seat is in the specific mode.

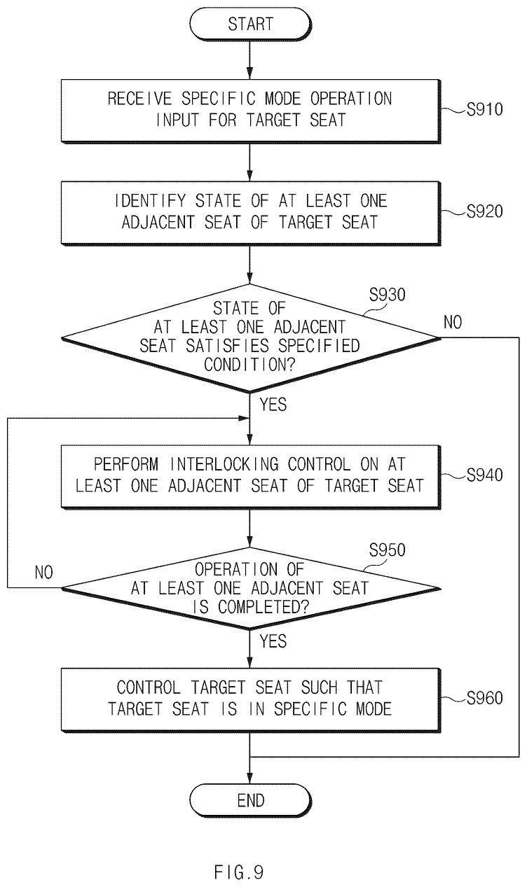

FIG. 9 is a flowchart illustrating an operation of a seat control apparatus, according to an embodiment of the present disclosure.

According to an embodiment, a seat control apparatus (e.g., the seat control apparatus 100 of FIG. 1) may perform operations described in FIG. 9. For example, at least some of components (e.g., the input device 110, the driving device 120, and/or the control device 140 of FIG. 1) the memory 130, included in the seat control apparatus may be configured to perform the operations of FIG. 9.

In the following embodiment, operation S910 to operation S960 may be sequentially performed, but are not always performed sequentially. For example, the order of operations may be changed, and at least two operations may be performed in parallel. Moreover, descriptions corresponding to or identical to the above-mentioned descriptions given with reference to FIG. 9 may be briefly described or omitted to avoid redundancy.

According to an embodiment, the seat control apparatus may receive a specific mode of operation input for a target seat (S910).

For example, the seat control apparatus may receive an operation input including a request signal for requesting control of a target seat such that the target seat is in a specific mode (or an operating mode), from a user through an input device.

For example, the specific mode may include at least one of a normal mode, a relaxation mode, a walk-in mode, a folding mode, or any combination thereof.

According to an embodiment, the seat control apparatus may identify a state of at least one adjacent seat of the target seat (S920).

According to an embodiment, the seat control apparatus may determine whether a state of at least one adjacent seat of the target seat satisfies a specified condition (S930).

For example, the specified condition may include a case that no one is seated in at least one seat, the at least one seat is not operated by another user, and a door of the host vehicle for at least one seat is open.

For example, when the state of the at least one adjacent seat satisfies the specified condition (e.g., operation S930—Yes), the seat control apparatus may perform operation S940.

For example, when the state of the at least one adjacent seat does not satisfy the specified condition (e.g., operation S930—No), the seat control apparatus may terminate the procedure.

According to an embodiment, the seat control apparatus may perform interlocking control on at least one adjacent seat of the target seat (S940).

For example, the seat control apparatus may identify an operating mode included in the operation input, may identify a specified state of the at least one adjacent seat corresponding to the operating mode, and may control the at least one adjacent seat such that the at least one adjacent seat interlocks with a specified state.

According to an embodiment, the seat control apparatus may determine whether an operation of the at least one adjacent seat is completed (S950).

For example, when the operation of the at least one adjacent seat is not completed (e.g., operation S950—No), the seat control apparatus may perform operation S940.

For example, when the operation of the at least one adjacent seat is completed (e.g., operation S950—Yes), the seat control apparatus may perform operation S960.

According to an embodiment, the seat control apparatus may allow the target seat to be in a specific mode (S960).

For example, the seat control apparatus may allow the target seat to be in an operating mode included in the operation input, based on the at least one adjacent seat completely operating in the specified state.

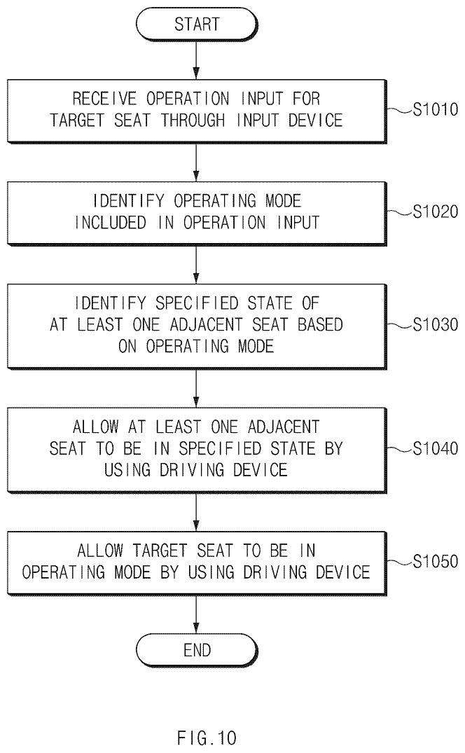

FIG. 10 is a flowchart illustrating an operation of a seat control apparatus, according to an embodiment of the present disclosure.

According to an embodiment, a seat control apparatus (e.g., the seat control apparatus 100 of FIG. 1) may perform operations described in FIG. 10. For example, at least some of components (e.g., the input device 110, the driving device 120, the memory 130, and/or the control device 140 of FIG. 1) included in the seat control apparatus may be configured to perform the operations of FIG. 9.

In the following embodiment, operation S1010 to operation S1050 may be sequentially performed, but are not always performed sequentially. For example, the order of operations may be changed, and at least two operations may be performed in parallel. Moreover, descriptions corresponding to or identical to the above-mentioned descriptions given with reference to FIG. 10 may be briefly described or omitted to avoid redundancy.

According to an embodiment, the seat control apparatus may receive an operation input for a target seat through an input device (S1010).

For example, the seat control apparatus may receive the operation input including the operating mode of the target seat from a user through an input device provided to control the operating mode of each of a plurality of seats mounted on the host vehicle.

For example, the input device may include a switch. For example, the input device may include a switch module including a plurality of structures related to an operating mode of a seat. For example, the input device may include a plurality of input devices (or switches) respectively corresponding to a plurality of seats included in the host vehicle. For example, at least part of input devices included in the input device may be implemented in a form of a touch screen.

According to an embodiment, the seat control apparatus may identify an operating mode included in the operation input (S1020).

For example, the operating mode may include at least one of a normal mode, a relaxation mode, a walk-in mode, a folding mode, or any combination thereof.

According to an embodiment, the seat control apparatus may identify the specified state of at least one adjacent seat based on the operating mode (S1030).

For example, the specified state may be set for the at least one adjacent seat adjacent to the target seat in response to the operating mode and may include a boundary section between an allowable state where interference does not occur due to the at least one adjacent seat and an unallowable state where interference occurs, in a process of controlling the target seat.

According to an embodiment, the seat control apparatus may allow at least one adjacent seat to be in a specified state by using a driving device (S1040).

For example, when a speed of the host vehicle is greater than or equal to a preset speed, a door of the host vehicle is closed, a risk of collision is detected while the host vehicle is driving, a user is seated in at least one adjacent seat, or the at least one adjacent seat is operating, the seat control apparatus may suspend control of the at least one adjacent seat and/or the target seat while receiving an operation input.

According to an embodiment, the seat control apparatus may allow the target seat to be in an operating mode by using a driving device (S1050).

For example, the seat control apparatus may allow the target seat to be in the operating mode, based on the at least one adjacent seat completely allowed to be in the specified state.

For example, when the specified time elapses from the start of control of at least one adjacent seat, or it is identified that at least one adjacent seat is not moved, the seat control apparatus may allow the target seat to be in the operating mode.

For example, the seat control apparatus may provide the user with the notification function by using the notification device at at least one of a point in time when at least one of at least one adjacent seat, the target seat, or any combination thereof starts to be controlled, a point in time when at least one adjacent seat is completely controlled, a point in time when it is identified that it is impossible to control at least one adjacent seat, a point in time when the target seat is completely controlled, or any combination thereof.

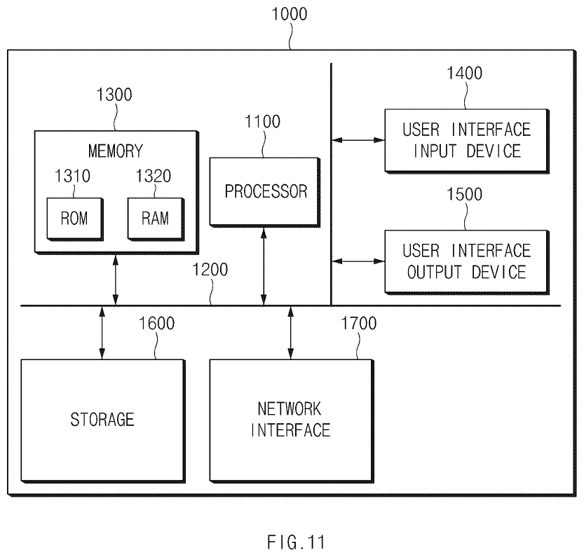

FIG. 11 illustrates a computing system related to a seat control method, according to an embodiment of the present disclosure.

Referring to FIG. 11, a computing system 1000 related to a seat control method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the disclosed embodiments in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one of ordinary skill in the art without departing from the essential characteristic of the present disclosure.

Accordingly, the disclosed embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Descriptions of a seat control apparatus and a method thereof according to an embodiment of the present disclosure are as follows.

According to at least one of the embodiments of the present disclosure, it is possible to prevent a situation in which interference occurs due to at least one of a space, a trajectory, or any combination thereof, which is occupied by each of a plurality of seats disposed in the host vehicle to enter a specific mode, and it is possible to provide an optimal seat control function.

Moreover, according to at least one of the embodiments of the present disclosure, an efficient seat control function may be provided by minimizing a communication load between components in the host vehicle, increasing a processing speed between a plurality of controllers, and simplifying the processing process.

Furthermore, according to at least one of the embodiments of the present disclosure, when an input for changing a mode of the target seat to a specific mode is received from the user, a seat control function may be provided to define a control signal that needs to be exchanged with adjacent seats depending on a location state of the target seat based on information of the specific mode included in the received input, to selectively apply a state transition condition of an operation sequence, and to adjust the timing for transitioning the operating sequence.

According to at least one of the embodiments of the present disclosure, in a situation where a state transition of the target seat or a neighboring seat is impossible or a state transition needs to be suspended, intuitive state information may be provided by guiding information about the above-mentioned situation to a user by using a notification device, and a seat control function may be provided to improve usability.

A variety of effects directly or indirectly understood through the present disclosure may be provided.

Although the present disclosure has been described with reference to various embodiments and the accompanying drawings, the present disclosure is not limited thereto. The embodiments may be variously modified and altered by those of ordinary skill in the art to which the present disclosure pertains without departing from the spirit and scope of the present disclosure claimed in the following claims.

What is claimed is:

1. A seat control apparatus, the apparatus comprising:
an input device;
a driving device;
a memory configured to store instructions; and
a control device electrically connected to the input device, the driving device, and the memory,
wherein the instructions, when executed by the control device, cause the seat control apparatus to
identify an operating mode included in an operation input when receiving the operation input to a target seat through the input device,
identify a specified state of at least one adjacent seat adjacent to the target seat based on the operating mode,
allow the at least one adjacent seat to be in the specified state by using the driving device, and
allow the target seat to be in the operating mode by using the driving device.

2. The apparatus of claim 1, wherein the instructions, when executed by the control device, further cause the seat control apparatus, when the operating mode is a relaxation mode, to:
forwardly slide a front seat of the target seat among the at least one adjacent seat by a first distance, control a reclining angle of the front seat such that the reclining angle of the front seat is forwardly changed by a 1-1st angle, control a cushion angle of the front seat such that the cushion angle of the front seat is downwardly changed by a 1-2nd angle, and control a reclining angle of a rear seat of the target seat among the at least one adjacent seat such that the reclining angle of the rear seat is changed to a maximum value or a minimum value, by using the driving device; or
backwardly slide the rear seat by the first distance and control the reclining angle of the rear seat such that the reclining angle of the rear seat is changed to the maximum value or the minimum value, by using the driving device.

3. The apparatus of claim 2, wherein the instructions, when executed by the control device, further cause the seat control apparatus, when the operating mode is a walk-in mode, to:
forwardly slide the front seat by a second distance different from the first distance, control the reclining angle of the front seat such that the reclining angle of the front seat is forwardly changed by a 2-1st angle different from the 1-1st angle, and control the cushion angle of the front seat such that the cushion angle of the front seat is downwardly changed by a 2-2nd angle, by using the driving device.

4. The apparatus of claim 1, wherein the instructions, when executed by the control device, further cause the seat control apparatus, when the operating mode is a folding mode, to:
control a reclining angle of a front seat of the target seat among the at least one adjacent seat such that the reclining angle of the front seat is forwardly changed by a third angle, by using the driving device.

5. The apparatus of claim 1, wherein the instructions, when executed by the control device, further cause the seat control apparatus to:
allow the target seat to be in the operating mode, based on the at least one adjacent seat completely allowed to be in the specified state.

6. The apparatus of claim 1, wherein the instructions, when executed by the control device, further cause the seat control apparatus to:
suspend control of the at least one adjacent seat and the target seat while an operation input is received, when a speed of a host vehicle is greater than or equal to a predetermined speed, when a door of the host vehicle is closed, when a risk of collision is detected while the host vehicle is driving, when a user is seated in the at least one adjacent seat, or when the at least one adjacent seat is operating.

7. The apparatus of claim 1, wherein the instructions, when executed by the control device, further cause the seat control apparatus to:
allow the target seat to be in the operating mode when a specified time elapses from a point in time when the at least one adjacent seat starts to be controlled, or when it is identified that the at least one adjacent seat is not moved.

8. The apparatus of claim 1, further comprising a notification device, wherein the instructions, when executed by the control device, further cause the seat control apparatus to provide a user with a notification function by using the notification device at at least one of:
a first point in time when at least one of the at least one adjacent seat, the target seat, or a combination thereof starts to be controlled;
a second point in time when the at least one adjacent seat is completely controlled;
a third point in time when it is identified that it is impossible to control the at least one adjacent seat;
a fourth point in time when the target seat is completely controlled;
or a combination thereof.

9. The apparatus of claim 8, wherein the instructions, when executed by the control device, further cause the seat control apparatus to:
change at least one of on/off of the notification function, a condition of allowing the target seat to be in the operating mode, or a combination thereof, based on settings of the user.

10. The apparatus of claim 1, wherein the specified state is set for the at least one adjacent seat adjacent to the target seat in response to the operating mode, and wherein the specified state includes a boundary section between an allowable state where interference does not occur due to the at least one e adjacent seat and an unallowable state where interference occurs, in a process of controlling the target seat.

11. A seat control method, the method comprising:
identifying, by a control device, an operating mode included in an operation input when receiving the operation input to a target seat through an input device;
identifying, by the control device, a specified state of at least one adjacent seat adjacent to the target seat based on the operating mode;
allowing, by the control device, the at least one adjacent seat to be in the specified state by using a driving device; and
allowing, by the control device, the target seat to be in the operating mode by using the driving device.

12. The method of claim 11, wherein allowing, by the control device, the target seat to be in the operating mode by using the driving device, when the operating mode is a relaxation mode, further includes:
forwardly sliding, by the control device, a front seat of the target seat among the at least one adjacent seat by a first distance, controlling a reclining angle of the front seat such that the reclining angle of the front seat is forwardly changed by a 1-1st angle, controlling a cushion angle of the front seat such that the cushion angle of the front seat is downwardly changed by a 1-2nd angle, and controlling a reclining angle of a rear seat of the target seat among the at least one adjacent seat such that the reclining angle of the rear seat is changed to a maximum value or a minimum value, by using the driving device; or
backwardly sliding, by the control device, the rear seat by the first distance and controlling the reclining angle of the rear seat such that the reclining angle of the rear seat is changed to the maximum value or the minimum value, by using the driving device.

13. The method of claim 12, wherein allowing, by the control device, the target seat to be in the operating mode by using the driving device, when the operating mode is a walk-in mode, further includes:
forwardly sliding, by the control device, the front seat by a second distance different from the first distance, controlling the reclining angle of the front seat such that the reclining angle of the front seat is forwardly changed by a 2-1st angle different from the 1-1st angle, and controlling the cushion angle of the front seat such that the cushion angle of the front seat is downwardly changed by a 2-2nd angle, by using the driving device.

14. The method of claim 11, wherein allowing, by the control device, the target seat to be in the operating mode by using the driving device, when the operating mode is a folding mode, further includes:
controlling, by the control device, a reclining angle of a front seat of the target seat among the at least one adjacent seat such that the reclining angle of the front seat is forwardly changed by a third angle, by using the driving device.

15. The method of claim 11, wherein allowing, by the control device, the target seat to be in the operating mode by using the driving device further includes:
allowing, by the control device, the target seat to be in the operating mode, based on the at least one adjacent seat completely allowed to be in the specified state.

16. The method of claim 11, further comprising:
suspending, by the control device, control of the at least one adjacent seat and the target seat while an operation input is received, when a speed of a host vehicle is greater than or equal to a predetermined speed, when a door of the host vehicle is closed, when a risk of collision is detected while the host vehicle is driving, when a user is seated in the at least one adjacent seat, or when the at least one adjacent seat is operating.

17. The method of claim 11, wherein allowing, by the control device, the target seat to be in the operating mode by using the driving device further includes:
allowing, by the control device, the target seat to be in the operating mode when a specified time elapses from a point in time when the at least one adjacent seat starts to be controlled, or when it is identified that the at least one adjacent seat is not moved.

18. The method of claim 11, further comprising providing, by the control device, a user with a notification function by using a notification device at at least one of:
a first point in time when at least one of the at least one adjacent seat, the target seat, or a combination thereof starts to be controlled;
a second point in time when the at least one adjacent seat is completely controlled;
a third point in time when it is identified that it is impossible to control the at least one adjacent seat;
a fourth point in time when the target seat is completely controlled;
or a combination thereof.

19. The method of claim 18, further comprising:
changing, by the control device, at least one of on/off of the notification function, a condition of allowing the target seat to be in the operating mode, or a combination thereof, based on settings of the user.

20. The method of claim 11, wherein the specified state is set for the at least one adjacent seat adjacent to the target seat in response to the operating mode, and wherein the specified state includes a boundary section between an allowable state where interference does not occur due to the at least one adjacent seat and an unallowable state where interference occurs, in a process of controlling the target seat.
